(19) United States
(12) Patent Application Publication
(10) Pub. No.: US 2009/0129873 A1
(43) Pub. Date: May 21, 2009

(54) METAL SANDING DEVICES

(76) Inventors: Christopher R. Grace, Russellville, AR (US); Richard L. Grace, Dover, AR (US); Daniel I. Duerr, Russellville, AR (US)

Correspondence Address: LADAS & PARRY LLP, 224 SOUTH MICHIGAN AVENUE, SUITE 1600, CHICAGO, IL, 60604, US

(21) Appl. No.: 12/064,260

(22) PCT Filed: Jul. 12, 2005
(86) PCT No.: PCT/US2005/024747

§ 371 Date: Feb. 20, 2008

(51) Int. Cl. B23D 71/00; B23D 73/12

(52) U.S. Cl. 407/29.13; 451/548

(57) ABSTRACT

A metallic disk (10) for use with a powered hand tool to remove measured small amounts of material from the surface of a workpiece to smooth the surface thereof. Each disk (10) being formed with an array of strategically placed abrader elements (14) in which each such abrader element (14) is formed with a series of projections (38) in the nature of teeth extending inwardly from an inner wall, defining an opening, toward the edge of the abrader element (14), and being raised above the surface of the disk to engage the surface of the workpiece.

The present invention relates generally to wood finishing materials and, in particular, to metallic devices for providing varying grades of finishes on wood and like materials.

### BACKGROUND OF THE INVENTION

1. Field of the Invention

This application is about the tools to create a finish on a wood product by removing any roughness therefrom. Since the smoothness of a wood surface became important, minuscule particles of wood have been removed from such surfaces by such abrasive devices as rasps, files and, the ever popular, sandpaper.

Sandpaper is available in several grit sizes and is selected according to the smoothness desired. In some instances, where the surface to be worked is rough, a wood worker might start out with a larger grit and work the surface down to a smaller grit.

Sandpaper has some inherent deficiencies, among them, the loss of grit, which is secured to a paper backing by an appropriate adhesive. Once adequate grit has been lost, the paper is no longer useful and must be replaced. This can happen several times on a single workpiece. Also, if and when the paper backing becomes damp or wet, the tendency is to ball up, and/or fall apart.

Finally, all of the aforementioned tools tend to load up. That is, removed particulate matter tends to fill grooves and spaces between teeth, grit and the like, rendering the tool useless for the purpose intended. A worker may stop and take the time to clean the teeth in a rasp or file, but a piece of sandpaper becomes rather useless.

2. Overview of the Prior Art

While the intrinsic value of sandpaper products is almost universally recognized, so too are the deficiencies. Among early patented efforts to eliminate the paper backing used in conventional sandpapers is Lambert U.S. Pat. No. 1,729,881, issued in 1929. Lambert teaches a rotary disk having a series of uniformly spaced punched cutting teeth. Lambert was primarily concerned with the positioning and rigidity of the disk, which was intended for use with a hand power tool, to avoid imbalance and the dangers of flying debris. Schwartz, in his U.S. Pat. No. 4,685,181 offers a slightly different shaped disk with teeth formed by drilling holes and then upsetting an edge of the opening.

While Lambert focused on a sanding device for a rotary tool, Benis et al. applied his thinking to a vibratory device in his U.S. Pat. No. 3,583,107 for a flexible sheet metal speed file. A uniform pattern of punched teeth were formed on a rectangular piece of malleable metal. The thrust of the patent was, however, directed to the flaps 29, 31 which were used to hold the device to the hand tool. Konrad U.S. Pat. No. 4,028,781 is a similar type device, and Young U.S. Pat. No. 5,683,292 is yet another abrading device with rows of upstanding, similarly oriented, teeth having angles of 45 to 135 degrees.

Having found devices for use with both rotary and vibratory power tools, Konrad U.S. Pat. No. 4,377,081 addresses the use of a metal belt surfacing tool which has been perforated to form teeth.

The shape of the teeth is a function of the punching device used to form them, as evidenced by the several patents discussed, together with Amsen U.S. Pat. No. 2,820,281, which teaches an abrasive device in which the teeth are formed by a punch which causes the upward tearing of the material so as to have five upstanding points. Kaufman, on the other hand, in his U.S. Pat. No. 3,468,079, creates a star-like tooth. Kaufman envisions his device as a callous remover.

It will be appreciated that when a punch, or stamping device, is used, the punch penetrated the metal material at a center point, and the material is literally torn, as the punch advances, from that central point to the root, or perimeter, of the tooth, which is determined by the depth of the punch. Each segment of torn material will define a sharp point which is intended to contact the material, e.g., wood, plastic or metal, and remove particles thereof.

Yet another inventor, Rickey Newmayer, has yet another device in the form of a rotary disk (U.S. Pat. No. 4,137,617) having square and/or circular teeth for the cutting of plastics. The formation of the Newmayer teeth is attributable, in the Newmayer specification, to two other patents, and both of those patents talk of punch and die methods.

There are several other patents found in the abrading art, all of which have one or more variations on essentially the same theme.

### SUMMARY OF THE INVENTION

The present invention comprises a multi-faceted abrading device, the basic design of which makes it compatible with both rotary, orbital and vibratory power hand tools to effect a finish of desired smoothness on a work piece of wooden material.

With the foregoing in mind, it is a primary objective to provide such a device that is capable of performing like sandpaper, while having none of the deficiencies of sandpaper as chronicled above.

Another objective of the present invention is to create a metallic abrading device that has the efficacy of sandpaper, in that it is capable of removing controlled amounts of material, irrespective of the direction in which it is moved, while having excellent durability and useful life.

It is yet another objective of the present invention to provide an abrading device which is usable either with a rotary hand tool or a vibratory hand tool, and which starts exceptionally sharp and stays sharp for extended periods of use. An objective related to the foregoing is that the device of the present invention will not clog or load up in a way which adversely effects its performance.

The foregoing, as well as other objects and advantages of the abrading device of the present invention, will become more evident from a reading of the following Detailed Description of a Preferred Embodiment, taken in concert with the drawings, wherein:

### BRIEF DESCRIPTION OF THE DRAWINGS

FIG. 1 is a side elevation of the working surface of the circular version of the abrading device of the present invention;

FIG. 2 is a side elevation of the working surface of the rectangular version of the abrading device of the present invention;

FIG. 3 is a partial cutaway view, in perspective, of an abrading element, in profile, constructed in accordance with the present invention, illustrating in considerable detail a relatively coarse abrading element used in such a device, upset so as to project upwardly from the surface of the disk upon which it is formed;

FIG. 4 is a perspective view of the cutaway of FIG. 3;

FIG. 5 is an enlarged cutaway view of a portion of FIG. 4, taken along lines 5-5 in order to show a typical tooth profile;

FIG. 6 is a side elevation of a view similar to FIG. 3, except that it represents a medium abrading element used in devices such as shown in FIGS. 1 and 2;

FIG. 7 is a side elevation similar to FIG. 6, except that it illustrates a more fine abrading element;

FIG. 8 is an alternative form of an abrader element in which cutting teeth are arranged in other than circular orientation;

FIG. 9 is yet another alternative abrading element, having a generally rectangular tooth configuration, useable in devices such as illustrated in FIGS. 1 and 2;

FIG. 10 is a form of the abrading element of FIG. 9, except with an additional tooth;

FIG. 11 is an abrading element similar in configuration to FIGS. 4, 6 and 7, with a modified cutting tooth form;

FIG. 12 is an enlarged partial view of a disk similar in nature to FIGS. 1 and 2, except cutting teeth are formed in a random pattern;

FIG. 13 is a view of an abrading element similar in operation to those of FIGS. 8 through 12, but illustrating an abrading element having an especially fine cutting edge form of the present invention;

FIG. 14 is an end view of the abrading element of FIG. 13; and,

FIG. 15 is a partial sectional view of the abrading element of FIG. 13.

### DETAILED DESCRIPTION OF A PREFERRED EMBODIMENT

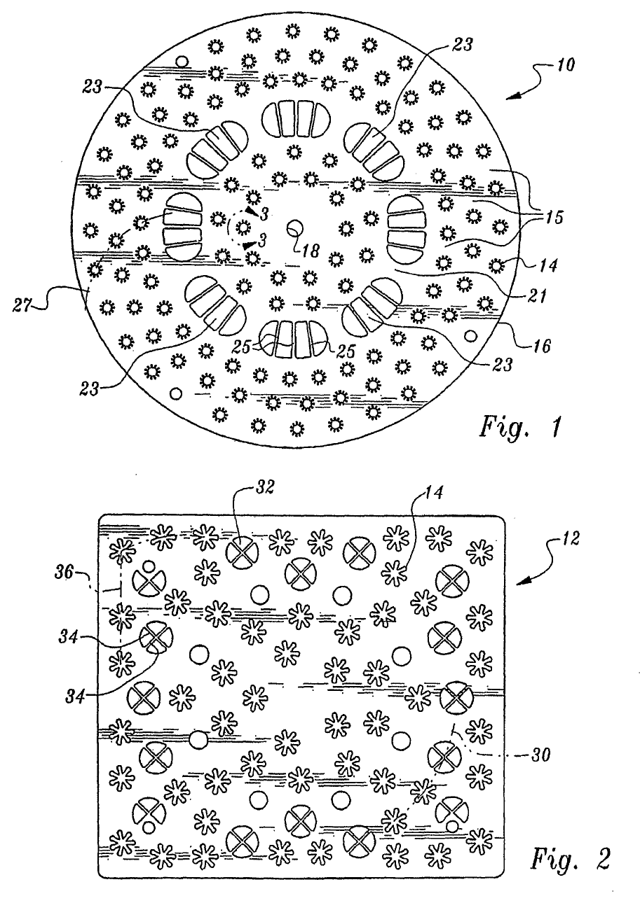

With reference now to the drawings, an omnidirectional device is shown and described. With initial focus on FIGS. 1 and 2, there is shown, respectively, a flat circular metal disk 10 and, in FIG. 2, a flat rectangular metal disk 12, capable of use with a powered hand held device, which is either rotary, orbital or vibratory in operation and usable to remove material from a workpiece as the disk is moved across the surface of the workpiece.

First with respect to the disk 10, an array of abrader elements 14 are formed thereon. Each of the abrader elements comprises an opening defined by an inner wall which may have an inner edge or edges. Projections may be formed along all, or a portion, of the edge or edges in the nature of teeth that are so disposed as to assure that material is removed from a workpiece irrespective of the direction of the movement of the disk by the hand tool to which it is affixed.

The abraders 14 are preferably, although not necessarily, arranged in concentric circles 15. Three such circles are toward the outer edge 16, while two additional circles are formed near the center aperture 18. The precise number of concentric circles of abrader elements may vary with the diameter of the disk.

As shown, the disk 10 is sized to be compatible with currently marketed rotary hand tools, but larger or smaller disks may be made without departure from the invention.

Returning to FIG. 1, the three outer rings 15 of abrader elements 14 and the two inner rings of abrader elements 14 are segregated on the disk 10 by a ring 21 of openings, or vents, 23. As illustrated, there are eight such vents 23, although the precise number may vary with the dimensions of the disk.

Each of the vents 23 are of an elongated, generally elliptical, configuration with a series of transverse, radially extending bars 25 segmenting the vents 23, adding stability to the disk and some protection against inadvertent cuts during handling. The vents 23 provide an element of air movement, permitting some cooling, and an exit for dust and other particulate matter which might pass behind the disk.

Still referring to FIG. 1, it is a feature of the present invention that the abrader elements 14 are spaced equidistant about each diameter, and the outer three rings of abrader elements are so aligned that each tooth in a ring is so aligned with a tooth in an adjacent ring of abrader elements, so as to form a series of arcs 27 with abrader elements on adjacent rings. This pattern has shown to have very effective benefits in the uniform removal of material from a workpiece.

Although the exterior shape is rectangular, the disk 12 of FIG. 2 has attributes similar to those discussed with respect to the circular embodiment of FIG. 1. Referring to FIG. 2, an array of abrader elements 14 are situate in a series of concentric rings, the outer one of which has been denominated as 30. Three additional concentric rings are found within the ring 30. The abrader elements of each ring are proportionally spaced about the ring and, in the ring 30, there are several vents 32. Each vent includes cross bars 34 and provides some limited increase in air flow, as is the case with the disk 12.

By virtue of its rectangular configuration, coupled with the circular distribution of the abrader elements 14, the corner areas of the disk are relatively unproductive. In order to remedy this potential inefficiency, the present invention provides a line of abrader elements 14 about each of the four corners of the disk 12. Still referring to FIG. 2, a generally “L” shaped string 36 of abrader elements is formed in each corner of the disk 14. Thus, when the disk is attached, as it is intended, to a vibratory hand tool, the entire surface of the disk will be engaged with, and able to dress, the workpiece to provide a coarse, medium or fine finish thereon.

With reference now to FIGS. 4 through 7, the tooth configuration of the present invention offers a novel and effective approach to the efficient surfacing of a workpiece.

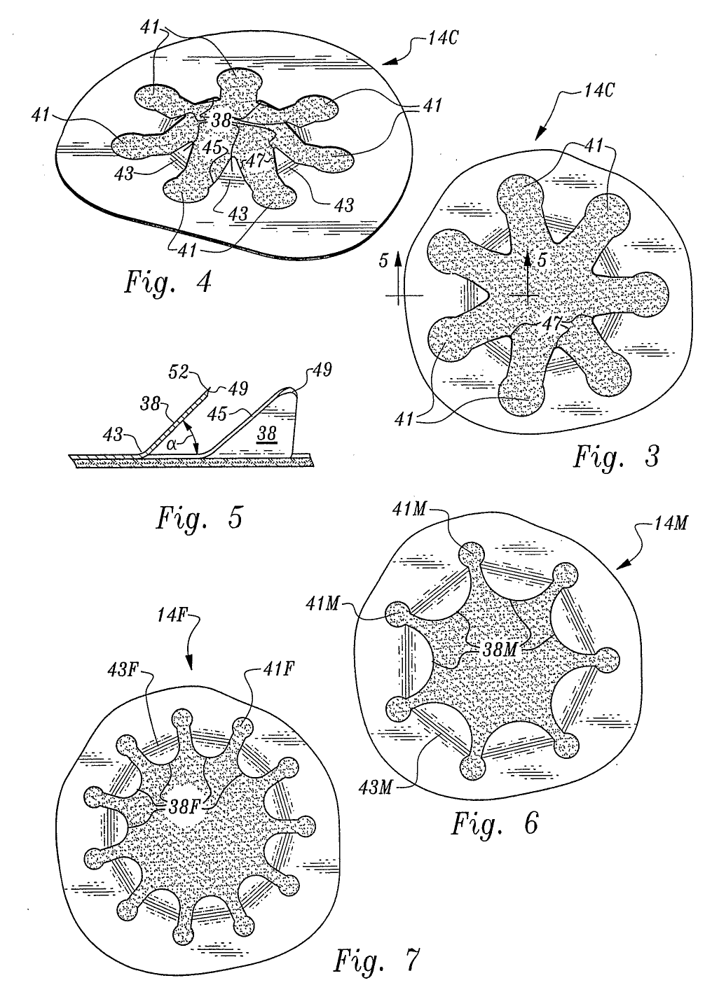

In keeping with the objectives of the present invention, a variety of abrader elements of varying cutting ability are provided in order to give the user options similar to those which are available to those who customarily use sandpaper. FIGS. 3, 4 and 5 are representative of an abrader element 14C which provides a more coarse finish to the surface of the workpiece.

A disk, e.g., disks 10 or 12, are preferably formed by a chemical etching process as taught in Sturtevant U.S. Pat. No. 5,100,506, although other methods may be employed without departure from the invention. The use of such a process removes the appropriate amount of metal, while simultaneously forming exceptionally sharp, yet stable, edges.

In the manufacturing process which results in the formation of disks of the present invention, there are simple steps which are to be undertaken, at least some of which can be accomplished simultaneously. An initial step is to form one or more voids, openings or holes in a disk, the precise shape of which may vary. Having formed one or more such voids, all or a portion of the edges of the holes, which may or may not include projections in the nature of teeth, are sharpened. Finally, those sharpened portions, or edges, are offset outwardly from the plane of the disk upon which they are formed.

Still referring to FIGS. 3, 4 and 5, the abrader element 14C is formed, or otherwise provided, with a series of seven teeth 38, arranged in a circle and separated by cutouts 41, the cutouts providing ample space between the teeth 38 to avoid clogging of the abraders 14.

Once the disk, with abrader elements, has been formed by, e.g., the photo chemical process previously identified, the individual teeth 38 are offset, such as by bending outwardly along a bend line 43 so as to protrude at an appropriate acute angle from the otherwise flat surface of the disk, as best seen in FIG. 5.

Each tooth 38 is formed with cutting edges 45 that face inwardly, and, in the case of FIG. 3, converge from the root of the tooth to a sharpened edge, or terminus, 47. All of the termini face generally inwardly in the FIG. 3 embodiment and converge from the root thereof toward the center of the abrading element, thereby permitting the removal of material from the workpiece, no matter which direction the disk is moved across the surface of the workpiece. It will be seen in keeping with the objective of creating a durable abrader element, the root of each tooth is slightly rounded in order to relieve stresses which might otherwise occur at that location while in use.

It will be observed in FIG. 5 that a bevel 49 is formed along the cutting edges of the tooth when the photo chemical process is used, which creates a sharp, yet strong, outer cutting edge 52 on each tooth, making the abrader elements very effective in the removal of minute amounts of material from the workpiece with each pass.

It is one of the objectives of the present invention to provide the versatility of sandpaper by offering disks with a more refined abrader element than that just described. To this end, an abrader element of medium cutting capability is shown at 14M in FIG. 6.

Each abrader element 14M is formed with a series of teeth 38M, again arranged in a circle and separated by cutouts 41M. Each tooth 38M, so defined has a semicircular configuration, as distinguished from a tooth 38C. Each of the teeth 38M has a similar profile, however, to that illustrated in FIG. 5 as to the formation of the bevel which provides the sharp edge for each tooth. Again, the teeth are bent outwardly along the bend line 43M.

A yet more refined version of the abrader element 14F is offered in FIG. 7. Each tooth 38F is similar in profile to the teeth 38M of FIG. 6, except that there are several more such teeth and they are of a lesser dimension than those of the medium abrader element. The formation process remains essentially the same, with teeth 38F being defined by cutouts 41F, and each tooth having a rounded, essentially arcuate configuration. In similar fashion, the teeth 38F are bent outwardly along a bend line 43F.

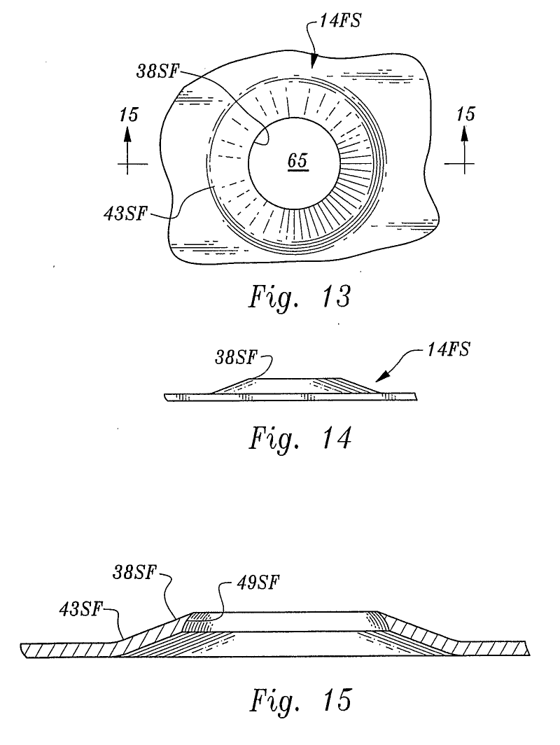

With reference now to FIGS. 13, 14 and 15, a further refinement is offered to the woodworker by means of another tooth configuration. FIG. 13 illustrates a super fine abrader element 14SF which is preferably, and most efficiently, formed by a photochemical etching process in which metal is removed to form an inner edge, or wall, 65, defining an opening. Once the opening is formed, which may be uniform or non uniform, at least a portion the edge is sharpened to define an inner cutting edge 38SF. The portion of the edge which is sharpened is then upset along bend line 43SF in a uniform fashion, to move the edge outwardly from the plane of the disk upon which the abrader element is formed.

As seen in FIG. 15, the edge is beveled, as at 49SF by the etching process to create a sharp and stable edge. The edge 14SF is continuous and able to remove small amounts of material from a workpiece in all directions of movement of a hand tool to which the disk is attached. The abrader element 14SF is capable of creating a finish on a wood workpiece which is comparable to the finest of sandpapers.

It is of particular interest to note that tests have been run on the disks of the present invention and, in particular, the coarse abrader version. It has been demonstrated that when compared to the leading brand of sandpaper, 60 grit, on a walnut workpiece, that the disk of the present invention demonstrated the capacity to remove more than four times the weight of particulate material in a given unit of time than the sandpaper and, further, was effective more than five times longer than the same sandpaper. With outstanding performance fully chronicled, the disks of the present invention stand alone in the field.

It will be further understood that by following the teachings of the present invention, devices of several different removal capacities, as distinguished from the three sizes, coarse, medium and fine, discussed may be made to compare to sandpaper, or the like, of various grit sizes. It will be further appreciated that while some abrader elements are shown as having a circular profile while others are non circular, it is by way of example only and varying grades of abrader elements may come in any one of several profiles.

With reference now to FIGS. 8 through 12, it is shown that the specific configuration of an abrader element may be effective in several configurations. For example, an abrader element 55 is illustrated in FIG. 8 as having an oval profile. The teeth 57, as in the case of other abraders, face inwardly and are offset in the manner previously described.

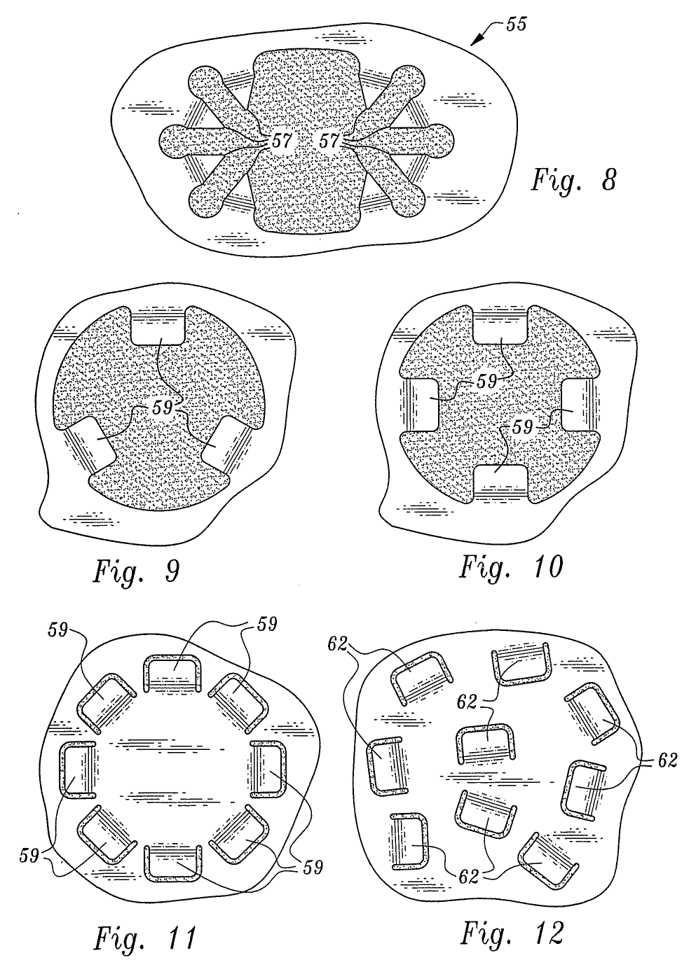

In FIGS. 9, 10 and 11, the profile of the abrader element is generally circular. However, the teeth 59 are more rectangular in profile, and, as the Figures indicate, the number of teeth may vary according to the intended use. Each tooth, as is the case in all variations in abrading elements, are formed with bevels along the cutting edges defined on the periphery of each tooth.

Finally, as a means of emphasizing the objective of the present invention to provide an omnidirectional tool, FIG. 12 graphically illustrates that teeth 62, in this instance, teeth, like teeth 59, may be formed in a random, non uniform, array. While not in some uniform or symmetric pattern, the teeth are nonetheless so arrayed that the cutting edges on a sanding device, so that when the sanding device is moved in any direction, material will be removed from a workpiece. It will be understood that the teeth may be clustered on the disk in any reasonable fashion, and, in fact, several different abrader elements may be arranged on the same disk with individual teeth such as 59 and 62, and in different profiles having the same rating in accordance with their ability to remove material and create a finish.

It will be appreciated that some differences in design may be undertaken without departure from the invention, which is defined by the accompanying claims, wherein:

1. An omnidirectional metallic sanding device for use with a hand power tool to remove material from a workpiece comprising a metallic disk, said disk having an array of abrader elements formed thereon;
each said abrader element being formed with a series of teeth; said teeth being positioned within said abrader element so as to provide removal of material from a workpiece regardless of the direction of movement of said disk;
each said tooth of said abrader element being offset outwardly from the plane of said disk to cause each tooth so as to engage a workpiece and remove material therefrom as said disk is moved there across.

2. The omnidirectional metallic sanding device of claim 1, wherein said abrading elements are formed by a photo chemical etching process.

3. The omnidirectional metallic sanding device of claim 1, wherein said metallic disk is circular.

4. The omnidirectional metallic sanding device of claim 1, wherein said metallic disk is rectangular.

5. The omnidirectional metallic sanding device of claim 1, wherein said abrader elements are arranged in a series of concentric rings.

6. The omnidirectional metallic sanding device of claim 5, wherein said abrader elements are proportionateley spaced on each said ring.

7. The omnidirectional metallic sanding device of claim 1, wherein each tooth terminates in a rounded tip.

8. The omnidirectional metallic sanding device of claim 5, wherein said adjacent abrader elements on adjacent concentric circles define an arc.

9. The omnidirectional metallic sanding device of claim 3, wherein a string of adjacent abrader elements is defined in the corners of said rectangular disk.

10. The omnidirectional metallic sanding device of claim 5, wherein a series of vents are formed on said disk, said vents are arranged in a ring, between rings of said abrader elements.

11. The omnidirectional metallic sanding device of claim 10, wherein each of said vents is formed with transverse bars.

12. An omnidirectional metallic sanding device for use with a hand power tool for removal of material from a work piece, said sanding device comprising a metallic disk, said disk having teeth formed thereon, each such tooth having at least one sharpened edge;
said teeth on said disk positioned so that movement of said metallic disk in any direction will result in removal of material from the workpiece;
each said tooth being offset outwardly from the plane of said disk in order that each tooth is positioned to engage a workpiece and remove material omnidirectionally therefrom as said disk is moved there across.

13. An omnidirectional abrader element formed on a metallic sanding device, each said abrader element formed with a series of inwardly oriented teeth;
each said tooth terminating in a sharpened cutting edge, said cutting edge having a bevel formed thereon;
each said tooth being bent outwardly from the plane of said metallic sanding device so that said sharpened edge thereof extends above the surface of said metallic sanding disk;
said teeth comprising each said abrader element being so arranged as to thereby provide omnidirectional removal of material from a work piece when said abrader element is moved across the surface of the workpiece.

14. The omnidirectional abrader element of claim 13, wherein the terminus of each tooth comprises an arcuate segment.

15. The omnidirectional abrader element of claim 13, wherein said abrader element having an array to teeth formed therein, and said abrader element being circular in profile.

16. The omnidirectional abrader element of claim 13, wherein each said abrader element is oval in profile.

17. The omnidirectional abrader element of claim 13, wherein said tooth is generally rectangular in configuration and having an edge thereabout defining a bevel.

18. The omnidirectional abrader element of claim 13, wherein said abrader element is formed by a photo chemical etching process.

19. An omnidirectional metallic sanding device for removal of material from a work piece; said sanding device having at least one abrader element, said abrader element being formed by first creating at least one opening in said disk; said opening have an interior wall;
thereafter sharpening edges about at least a portion of said interior wall; and offsetting said sharpened edges from the plane of said disk such that said sharpened edges cause removal of material from the workpiece irrespective of the direction of movement of said abrader element.

20. The omnidirectional metallic sanding device of claim 19, wherein projections are formed along said interior wall of said opening; said projections having sharpened edges, said sharpened edges being beveled.

21. The omnidirectional metallic sanding device of claim 19, wherein said opening is formed and sharpening of said interior wall of said opening is accomplished in a single step.

22. The omnidirectional metallic sanding device of claim 21, wherein the creation of said opening and the sharpening process are accomplished by photo chemical etching.

23. An omnidirectional metallic sanding device for removal of material from a workpiece; said metallic sanding device comprising a metallic disk; at least one abrader element formed on said disk;
each abrader element having an interior wall, at least a part of said interior wall being sharpened to form a cutting edge, and said part of said wall defining said cutting edge raised above the metal plane surface in order that material may be removed irrespective of the direction of the movement thereon.

24. The omnidirectional metallic device of claim 23, wherein said wall of said abrader element contains at least one inwardly facing protrusion; said protrusion defining a tooth.

25. The omnidirectional metallic device of claim 23, wherein said abrader element is formed by the process of photo chemical etching.
